(19) United States
(12) Patent Application Publication
(10) Pub. No.: US 2005/0177305 A1
(43) Pub. Date: Aug. 11, 2005

(54) Display method and apparatus for navigation system

(76) Inventor: Maung W. Han, Torrance, CA (US)

Correspondence Address: MURAMATSU & ASSOCIATES, Suite 225, 7700 Irvine Center Drive, Irvine, CA, 92618, US

(21) Appl. No.: 10/774,087

(22) Filed: Feb. 6, 2004

(51) Int. Cl. G01C 21/32

(52) U.S. Cl. 701/211; 340/995.14

(57) ABSTRACT

A display method and apparatus for a navigation system which is capable of preventing blank scroll of a display screen when there is no visible objects within a display range when the screen is scrolled and immediately jumping to the screen where a visible object exists. When a display screen is scrolled, if there is no visible object within a display range of the scroll for a relatively long period of time, the display screen just shows a blank screen, which may confuse the user or make the user feel uneasy. The display method and apparatus avoids the blank scrolling by automatically scrolling to a screen where a visible object is shown.

### FIELD OF THE INVENTION

This invention relates to a display method and apparatus for a navigation system, and more particularly, to a display method and apparatus for a navigation system which is capable of preventing blank scroll of a display screen where there is no visible objects within a display range when the screen is scrolled, and immediately jumping to the screen where a visible object exists.

### BACKGROUND OF THE INVENTION

A navigation system, typically a vehicle navigation system, performs travel guidance for enabling a user to easily travel to a selected destination. Such a navigation system detects the position of the user or a vehicle having the navigation system, reads out map data pertaining to an area from a data storage medium, for example, a CD-ROM (compact disk read-only memory) or a DVD (digital videodisc) or a hard disc. The current position of the user (vehicle) is determined by a combination of a self-contained navigation sensors (distance traveled sensor, bearing sensor, etc.) and a global positioning system (GPS) satellite.

FIGS. 1A-1H show an example of overall procedure and screen display involved in the navigation system. FIG. 1A shows an example of locator map screen of the navigation system when the destination is not specified. Typically, the navigation system displays a street on which the vehicle (current vehicle position VP) is running on a map image and a name of the street. Other information such as a north pointer NP, a map scale and a current time may also be illustrated on the display screen.

FIGS. 1B-1D show an example of process for specifying a destination in the navigation system. A main menu screen such as shown in FIG. 1B displays menu items including a “Destination” menu for entering the destination. When selecting “Destination”, the navigation system displays a “Find Destination by” screen as shown in FIG. 1C for specifying an input method for selecting the destination. The “Find Destination By” screen lists various methods for selecting the destination including “Address” for specifying the city and address of the destination, “Intersection” for specifying the names of two streets which intersect with one another, and “Point of Interest” (POI) for selecting the programmed destination based on the name, category or telephone number. Other methods in the “Find Destination by” screen include “Recent Route” for specifying the destination based on the recent history of destinations saved in the navigation system, and “Address Book” for selecting the address of the destination out of the prescribed address list stored in the system.

When selecting, for example, the “Point of Interest” method in FIG. 1C, the navigation system displays selection methods of point of interest (POI) either by “Place Name” or “Place Type” in FIG. 1D. The “Place Name” is to specify a name of POI, and the “Place Type” is to specify a category of POI. If the “Place Name” is selected in FIG. 1D, the navigation system shows an “Enter Place Name” screen such as shown in FIG. 1E. The screen of FIG. 1E is basically a keyboard for inputting the name in an input box on the monitor screen. The user inputs the name of the desired POI in the input box through the keyboard.

FIG. 1F shows a “Confirm Route” screen of the navigation system for confirming the destination. In this example, the “Confirm Route” screen lists the name, address and phone number of the destination (i.e., the POI specified by the user). If this is the correct destination, the user enters an “OK to Proceed” key to proceed to the next procedure.

In FIG. 1G, the navigation system calculates and determines a guided route to the destination, i.e., the selected POI. The navigation system determines a route to the destination based on, for example, the shortest way to reach the destination, the route using as much freeway as practical or the route without using toll road, or the like. After determining the guided route, the navigation system starts the route guidance as shown in FIG. 1H. Typically, the navigation system shows the intersection which is highlighted to show the next turn and a direction of the turn. Such route guidance by the navigation system is also given by voice instructions.

During the map screen mode of FIG. 1A or route guidance mode of FIG. 1H, there arises a situation where a user wants to see a place or places outside of the map currently displayed on the screen. For example, before entering the route guidance mode, a user wants to specify a destination on the map image rather than inputting a place name or selecting the prestored address data. Even during the route guidance mode, the user may want to temporarily leave the guided route to go to a restaurant, or other points of interest. In other instance, a user may want to compare two areas, which are far apart from one another and thus outside of the current display screen.

In the navigation system, such areas outside of the current screen can be displayed by scrolling the screen. FIGS. 2A and 2B show an example of display of the scroll function for shifting the map screen on the display. By operating scroll keys in up-down and right-left directions, what was outside of the screen view of FIG. 2A becomes visible within the screen view of FIG. 2B. However, when a user travels in a large plain area such as a prairie, a desert or a lake, etc., the navigation system merely shows a blank screen since the areas scrolled do not contain any visible objects such as a pond, a building, other roads, etc. Hereafter, such a situation in the scroll operation is referred to as “blank scroll”.

An example of situation where the blank scroll arises is shown in FIGS. 3 and 4. FIG. 3 shows a map image where the user (vehicle position VP) is driving toward the desert area which has no road. A scale indicator 19 indicates the scale of the map image on the display screen 21. Suppose the user scrolls the screen 21 in the direction shown by the arrows in FIGS. 3 and 4 where there is no specific objects exists in the wide desert area, the screen 21 merely shows the blank screen with a single color.

This is because the map data from the map data storage (ex. DVD, hard disc in the navigation system) contains only position data (latitude and longitude) of the area but no segment data. Thus, as shown in FIG. 4, when the screen 21(1) is scrolled toward the scroll direction indicated by the arrow, the navigation system displays blank screens 21(2), 21(3) . . . , until the screen 21(n) which contains a visible object (pond 23 in the desert). Since the blank scroll screen such as screen 21(2) or 21(3) does not show anything thereon, the user can lose sense of direction, feels uneasy, and is confused. In such a situation, the user may keep scrolling the display until an object can be seen on the display. The user may also zoom out the display to see a wider perspective of the map image. However, such operations of the navigation system take some time and distract the user's attention from the safe driving.

Accordingly, it is desired that some means be provided to a navigation system to prevent the blank scroll so that the user feels at ease and maintain the safe driving. Namely, there is a need in a navigation system, when there is no visible artifacts in the display range in the scroll direction, that the navigation system is able to detect a visible artifact in the scroll direction, and quickly move to the screen where the visible artifact is shown.

### SUMMARY OF THE INVENTION

It is, therefore, an object of the present invention to provide a display method and apparatus for a navigation system which is capable of avoiding a blank scroll screen when the display screen is scrolled.

It is another object of the present invention to provide a display method and apparatus for a navigation system which is capable of detecting the situation of the blank scroll, searching any visible object within a display range in the scroll direction, and jumping to the screen where the visible object is displayed.

It is a further object of the present invention to provide a display method and apparatus for a navigation system which is capable of avoiding the blank scroll and quickly showing a visible object in the scroll direction, thereby achieving easy operation of the navigation system and safe driving of the vehicle.

It is a further object of the present invention to provide a display method and apparatus for a navigation system which is capable of quickly moving to a screen having a visible object with a small number of key operation.

It is a further object of the present invention to provide a display method and apparatus for a navigation system which is capable of achieving an easier and friendlier user interface.

One aspect of the present invention is a display method for a navigation system. The display method is comprised of the steps of: receiving a scroll signal from an input device operated by a user for scrolling a screen of a navigation system; detecting a condition in which blank scroll will arise when the screen is scrolled, where the blank scroll is a situation of the screen which does not show any visible object thereon; reading map data ahead in a scroll direction to find any visible object when the blank scroll condition is detected; evaluating a shape point on a visible object to determine whether any part of the visible object should come within a display range of the screen when the screen is further scrolled; and jumping to a location which shows the visible object when it is determined that any part of the visible object should come within the display range.

In the display method, the process of detecting the blank scroll condition is conducted by scanning the screen to see if there is any color difference on the screen, and if there is not a sufficient color difference, it is determined that the blank scroll condition exists. Alternatively, the process of detecting the blank scroll condition is conducted by examining map data for the screen to see if there is any data showing a visible object within the display range of the screen, and if there is not the map data showing the visible object, it is determined that the blank scroll condition exists.

The display method of the present invention repeats the steps of reading the map data ahead in the scroll direction to find any visible object and evaluating a shape point on the visible object until a visible object that should come within the display range is detected. In the step of reading the map data ahead in the scroll direction, the method determines the scroll direction based on the scroll signal generated by the input device. The display method evaluates a plurality of shape points on the visible object to determine which part of the visible object should come within the display range.

The display method includes a step of drawing a first line from one corner of the screen which is one end of the display range to the shape point and a second line from another corner of the screen which is another end of the display range to the shape point, and a step of evaluating an angle α made by the first line, an angle β made by the second line, and an angle θ of the scroll direction for determining whether the shape point will be within the display range when the screen scroll is continued. In one example, the shape point will not come within the display range if a relationship of “α>θ and β>θ” or “α<θ and β<θ” is satisfied.

Another aspect of the present invention is a display apparatus for a navigation system for implementing the various steps defined in the display method of the present invention noted above. Upon detecting the blank scroll condition, the display apparatus evaluates the map data in the scroll direction to find any visible object, evaluates the shape points on a visible object to determine whether any part of the visible object should come within a display range, and jumps to the location which shows the visible object.

According to the present invention, when the user scrolls the screen, since the navigation system is able to automatically move to the next visible object when the blank screen condition occurs, the user can maintain the sense of direction. In the application to the vehicle navigation system, the present invention contributes to safe driving by allowing the user to focus on the driving rather than operating the keys of the navigation system by quickly and easily moving to the screen showing a visible object. The present invention makes it possible to quickly scroll the screen to the location where a visible object exists with a small number of key operation. Accordingly, the present invention is also able to provide an easier and friendlier user interface.

### BRIEF DESCRIPTION OF THE DRAWINGS

FIGS. 1A-1H are schematic diagrams showing an example of process and screen display of a navigation system for specifying one or more destinations, determining a route to the destination, and guiding the user to the destination.

FIGS. 2A and 2B are schematic diagrams showing an example of shifting the map image by using a scroll function of a navigation system to bring in the map image that has been outside of the screen of the navigation system.

FIG. 3 is a display example of the present invention showing the situation where a user is driving toward a wide desert area where no visible artifacts exist.

FIG. 4 is an example of blank scroll condition where the user scrolls the display screen in the direction indicated by the arrow in the situation of FIG. 3.

FIG. 5 is a block diagram showing an example of structure in a vehicle navigation system for implementing the present invention for avoiding the blank scrolling and jumping to the screen showing a visible object.

FIG. 6 is a functional block diagram showing a basic structure of the apparatus of the present invention for avoiding the blank scrolling and jumping to the screen showing the visible object.

FIG. 7 is a schematic diagram explaining an example of process for determining whether a shape point of a viewable object in the scroll direction is actually within a display range as the user proceeds his scroll operation in accordance with the present invention.

FIG. 8 is a schematic diagram explaining another example of process for determining whether a shape point of a viewable object in the scroll direction is actually within a display range as the user proceeds his scroll operation in accordance with the present invention.

FIG. 9 is a schematic diagram explaining a further example of process for determining whether a shape point of a viewable object in the scroll direction is actually within a display range as the user proceeds his scroll operation in accordance with the present invention.

FIG. 10 is a schematic diagram explaining a further example of process for determining whether a shape point of a viewable object in the scroll direction is actually within a display range as the user proceeds his scroll operation in accordance with the present invention.

FIG. 11 is a view showing a real line and its approximation on a display screen of the navigation system in an actual implementation of the present invention.

FIG. 12 is a flow chart describing the basic operational process for determining whether shape points of the visible object will be within a display range when the scroll operation is continued.

FIGS. 13A and 13B are schematic diagrams for comparison between the prior art technology and the effect of the present invention where FIG. 13A shows the screen which involves the blank scrolling in the prior art and FIG. 13B shows the screen of the present invention which avoids the blank scrolling.

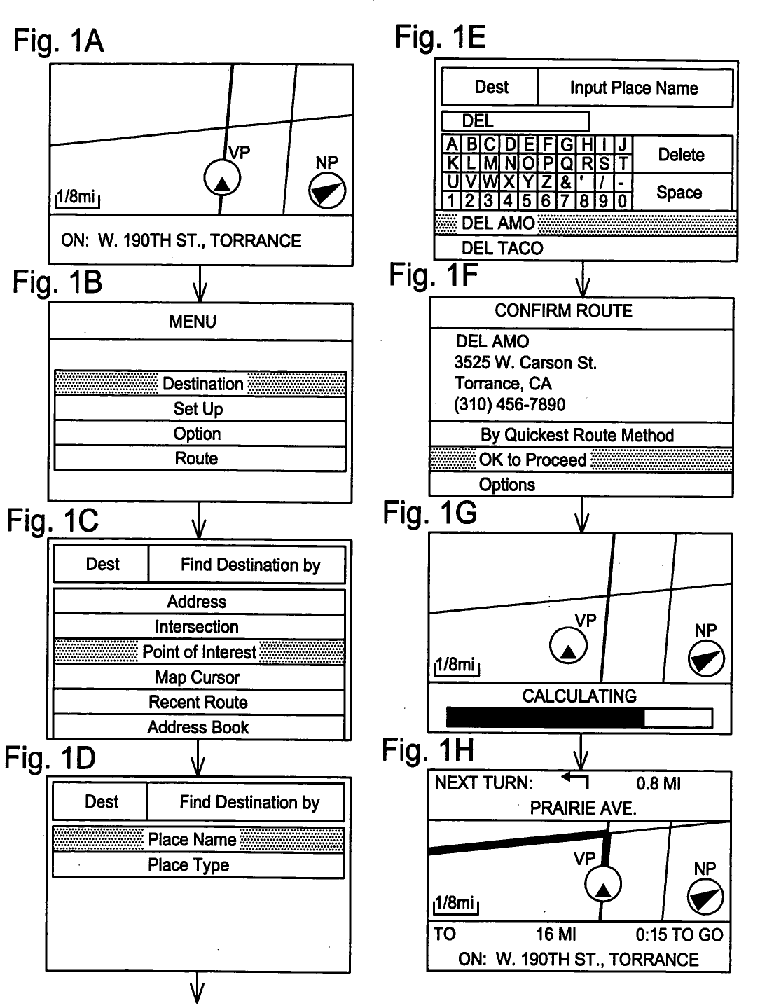

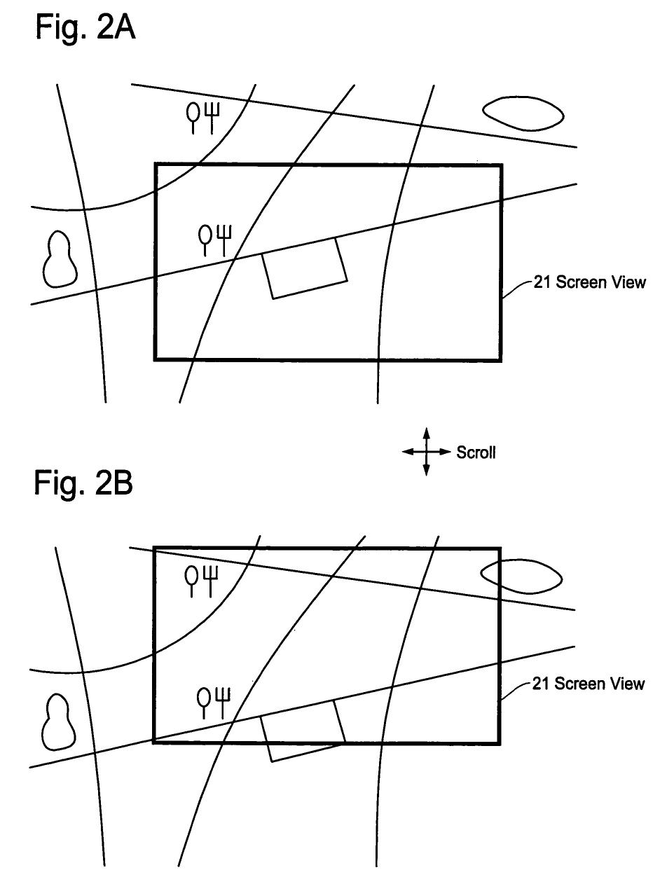

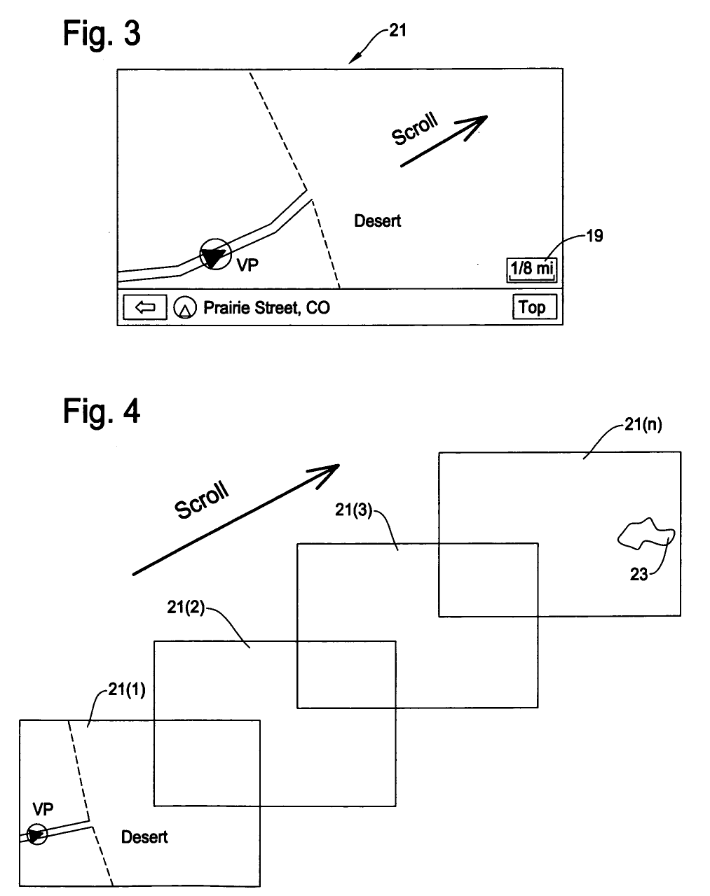

### DETAILED DESCRIPTION OF THE INVENTION

The display method and apparatus of the present invention for preventing the blank scroll of the screen will be described in detail with reference to the accompanying drawings. When a display screen is scrolled, if there is no visible object within a display range of the scroll for a relatively long period of time, the display screen just shows a blank screen, which may confuse the user or make the user feel uneasy. The present invention avoids the blank scrolling by automatically scrolling to a screen where a visible object is shown, thereby allowing the user to retain the sense of direction.

When a display screen is scrolled on an area where there is no visible object, the display method of the present invention prevents the blank scroll by detecting such a condition and rapidly moving to the screen in the scroll direction where a visible object exists. For example, if the user uses scroll key when the map image on the current screen is a desert, a lake, a prairie, etc., the navigation system detects that there is no visible object in the direction of the scroll for a while, and calculates a predicted location where a visible object will be seen. Then, the navigation system jumps to the predicted location of the scroll to display the visible object on the screen.

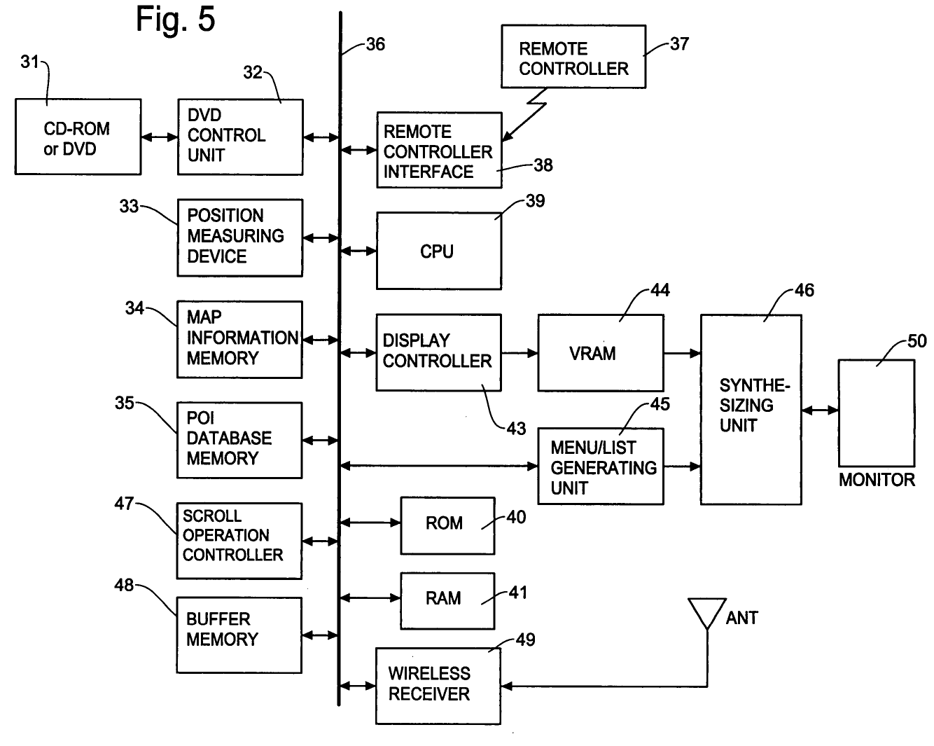

The display method and apparatus of the present invention is advantageously applicable to a vehicle navigation system. FIG. 5 shows an example of structure of a vehicle navigation system implementing the present invention. It should be noted that the present invention can also be applied to a portable navigation device such as a one implemented by a PDA (personal digital assistant) device, a lap-top computer, or other hand-held devices.

In the block diagram of FIG. 5, the navigation system includes a map storage medium 31 such as a CD-ROM, DVD, hard disc or other storage means (hereafter “DVD”) for storing map information, a DVD control unit 32 for a controlling an operation for reading the map information from the DVD, a position measuring device 33 for measuring the present vehicle position. The position measuring device 33 has a vehicle speed sensor for detecting a moving distance, a gyroscope for detecting a moving direction, a microprocessor for calculating a position, a GPS receiver, and etc.

The block diagram of FIG. 5 further includes a map information (data) memory 34 for storing the map information which is read out from the DVD 31, a database memory 35 for storing database information such as point of interest (POI) information which is read out from the DVD 31, a remote controller 37 for executing a menu selection operation, an enlarge/reduce operation, a destination input operation, etc. and a remote controller interface 38.

The navigation system further includes a bus 36 for interfacing the above units in the system, a processor (CPU) 39 for controlling an overall operation of the navigation system, a ROM 40 for storing various control programs such as a route search program and a map matching program necessary for navigation control, a RAM 41 for storing a processing result such as a guide route, a display controller 43 for generating a map image (a map guide image and an arrow guide image) on the basis of the map information, a VRAM (Video RAM) 44 for storing images generated by the display controller, a menu/list generating unit 45 for generating menu image/various list images, a synthesizing unit 46, a scroll operation controller 47, a buffer memory 48, a wireless receiver 49, and a monitor (display) 50.

The scroll operation controller 47 performs the essential function of the present invention for detecting the condition causing the blank scroll, searching a location in the scroll direction where any visible object exists, and jumping to the location. The scroll operation controller 47 receives map data from the map data storage 31 and scroll signals from an input device such as a remote controller 37. If necessary, the scroll operation controller 47 also receives information indicating the current position of the user from the position measuring device 33.

Such information may be temporarily stored in the buffer memory 48 for data processing. When receiving the scroll signals, the scroll operation controller 47 evaluates the map data to be displayed on the monitor 50 to check whether the blank scroll situation will be created if the scroll operation is continued in the scroll direction indicated by the scroll signals. If such a blank scroll condition is found, the scroll operation controller 47 evaluates the map data in the scroll direction to search any visible object. If any part of the visible object should be within the display range 21 in the scroll direction, the scroll operation controller 47 causes the monitor to immediately display the location where the visible object exists.

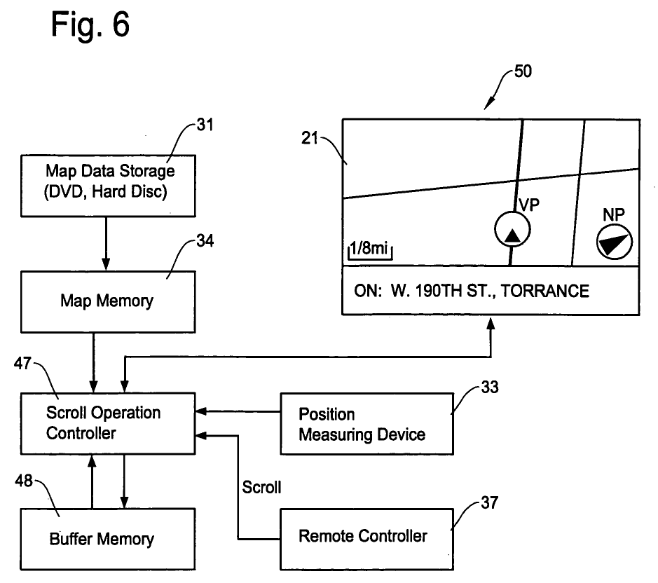

FIG. 6 is a functional block diagram showing an example of basic structure of the apparatus of the present invention for avoiding the blank scroll and jumping to the location in the scroll direction where the visible object will be displayed. The structure of FIG. 6 is illustrated by the components in the block diagram of FIG. 5 that are directly related to the operation of the present invention. The components of the apparatus of the present invention includes a monitor 50 for interfacing with the user, and a scroll operation controller 47 for controlling an overall operation of the apparatus of the present invention.

The block diagram of FIG. 6 further includes a map data storage 31 such as a DVD or a hard disc for storing map data, a map memory 34 for storing map data from the map data storage 31, a position measuring device 33 for detecting a current position of the user, an input device such as a remote controller 37 for entering command signals including scroll signals, and a buffer memory 48 for temporarily storing various types of data for processing and operation of the apparatus. In an actual application, the scroll operation controller 47 can be implemented by the CPU 39 in FIG. 5 or by a separate controller such as a microprocessor. Further, the buffer memory 48 can be implemented by RAM 41 in FIG. 5 or other memory.

As shown in FIG. 6, the navigation system is able to retrieve the map data from the map memory 34 and map data storage 31. For the map image displayed on the monitor 50, the user operates the input device, for example, the remote controller 37 to scroll the map image. The scroll operation controller 47 evaluates the scroll signals from the remote controller 37 and the map data from the map memory 34 to detect whether any blank scroll will arise in the display range when the screen 21 is scrolled.

The scroll operation controller 47 is able to detect such blank scroll condition by, for example, checking whether there is any change in the color of the map image to be displayed on the screen 21, or whether there is any data indicating a visible object in the map data for the display range of the screen 21. Upon detecting the blank scroll condition, the scroll operation controller 47 requests the map memory 34 to read out the map data ahead in the scroll direction. If the map memory 34 does not store sufficient map data, the map memory 34 retrieves the requested map data from the map data storage 31. The scroll operation controller 47 examines the map data in the scroll direction until any visible object is found therein.

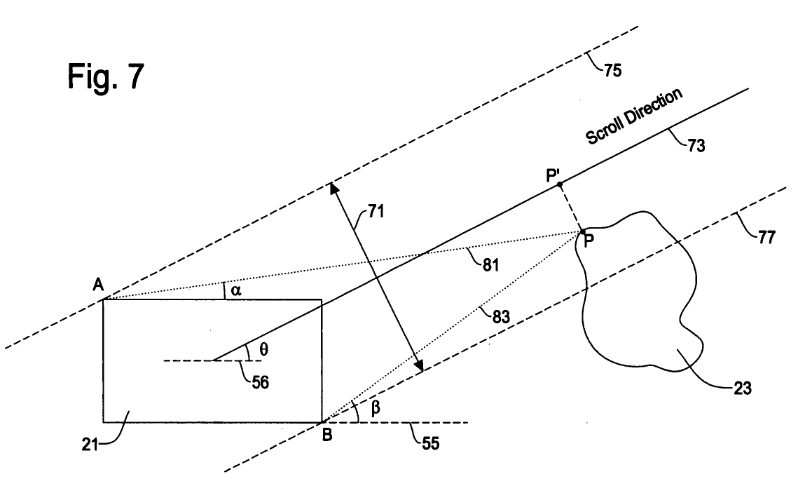

When a visible object is found in the scroll direction, the scroll operation controller 47 further examines whether any part of the visible object will be within the display range when the screen 21 is continuously scroll in the scroll direction. As will be described with reference to FIGS. 7-10, such determination is made by evaluating the angles involved with a shape point of the visible object. During such evaluation, the map data will be temporarily stored in the buffer memory 48 or in the map memory 34. If it is determined that any part of the visible object should come within the display range in the scroll direction, the scroll operation controller 47 causes the monitor 50 to display to the location where the visible object will be displayed. In other words, the map image on the screen 21 jumps to the new location that shows the visible object.

FIGS. 7-10 show an example of process for determining whether any part of a visible object in the scroll direction should actually be within a display range when keep scrolling in accordance with the display method and apparatus of the present invention. It should be noted that FIGS. 7 to 10 are shown only to explain the steps for determining visible artifacts, thus, the user will not see those illustrations on the actual display of the navigation system. As noted above, once the blank scroll condition is detected, the navigation system searches a visible object that would come within the display area when the scroll operation is continued in the selected scroll direction. Then, the navigation system jumps to the location where the visible object exists without showing the blank screen.

First, when the scroll key such as on the remote controller 37 is operated by the user, the navigation system checks whether there is any condition that causes the blank scroll by, for example, scanning the display to see if there is any color difference on the screen or checking the map data for the screen. As noted above, such condition arises when the user scrolls the screen of the map image where there is no map data of visible objects. Typically, the map data in the map data storage 31 (FIGS. 5 and 6) do not include any data of visible object other than latitude/longitude data for the middle of a large lake, prairie, desert, jungle, and the like. Thus, if the user scrolls the screen of the map image on the lake, prairie, desert, etc., the conventional navigation system displays only a blank screen.

In the navigation system of the present invention, however, if such a blank scroll condition is detected, the navigation system immediately stops the scrolling even if the scroll signals are received from the input device and searches any visible object in the scroll direction by reading the map data ahead. The process to determine whether a particular object should come in the display range is conducted by evaluating the angles of the point of the object as described below. If a visible object is detected, the navigation system directly moves to the location where the visible object exists in the scroll direction. Thus, the user does not have to see the blank screen when scrolling the screen.

In FIG. 7 shows an example of illustration to determine whether an object in the scroll direction should be in the display range if the scroll operation by the user is continued. This illustration corresponds to the map image of FIG. 4 where there is a pond 23 far ahead in the scroll direction. The navigation system determines whether the pond 23 should be within the display range if the user keeps scrolling the screen in the same scroll direction.

In FIG. 7, a line 73 (scroll direction line) is drawn from the center of the display screen 21 to the scroll direction. Since the user initially operates the scroll keys on the remote controller 37, the navigation system knows the scroll direction based on the scroll signals from the remote controller. A line 75 is also drawn in the scroll direction in parallel with the line 73. The starting point of the line 75 is a point A that is an upper left corner of the display screen 21. Further, a line 77 is drawn in the scroll direction in parallel with the line 73. The starting point of the line 77 is a point B that is a lower bottom corner of the display screen 21.

In this particular scroll direction, the point A (first end of the display range) and the point B (second end of the display range) define the maximum display range of the current screen 21 when the screen 21 is continuously scrolled. Thus, the lines 75 and 77 form the display range having the width 71 in which any part of object within the range should be displayed when the scroll operation is continued. In other words, if a part of a particular object, such as the pond 23 is within the display range of the scroll operation, the navigation system jumps to the screen showing the pond 23 without showing the blank screen on the way. In the case where not any part of the pond 23 is in the display range, the navigation system does not stop at this location and continues to search any object in further ahead of the scroll direction until the first object within the display range will be detected.

In the example of FIG. 7, the pond 23 has a shape point P that defines its shape. Although only one shape point P is shown in FIG. 7, the pond 23 has a large number of shape points, and the evaluation will also be made on the other shape points as will be explained in detail. The number of shape points that a visible object has depend on the size and shape of the visible object. Some visible object may have only a few shape points and others may have several hundreds of shape points.

A line 81 is drawn from the point A of the screen 21 to the shape point P. An angle formed by the line 81 and an upper horizontal side of the display screen 21 having the point A is defined as an angle α. A line 83 is drawn from the point B of the screen 21 to the shape point P. An angle formed by the line 83 and a lower horizontal side (extended line 55) of the display screen having the point B is defined as an angle β. An angle θ is defined by the scroll direction line 73 and a center horizontal line 56 parallel to the horizontal sides of the display screen 21.

The navigation system determines whether the pond 23 should be visible by comparing the angles α and β with the angle θ in FIG. 7. More particularly, the navigation system checks to see whether the condition which satisfies the relationship of “α>θ and β>θ” or “α<θ and β<θ”. If both of the angles α and β are either larger than the angle θ or smaller than the angle θ, i.e., “α>θ and β>θ” or “α<θ and β<θ”, then the point P of the pond 23 is not visible. In other words, if those conditions are not met, the navigation system determines that the object should be visible. In the present case of FIG. 7, because the angle α is smaller than the angle θ while the angle β is larger than the angle θ, the point P of the pond 23 is visible.

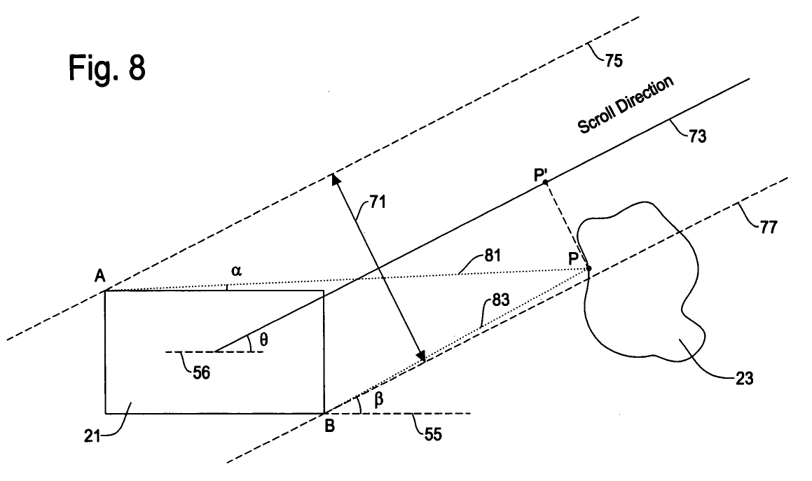

As explained above, the pond 23 has a plurality of shape points. Since the pond 23 is a relatively large object, the navigation system checks as to which part of the pond or all of the pond 23 should be displayed. Thus, the navigation system will check each shape point of the pond 23. In FIG. 8, the navigation system checks the shape point Pₙ of the pond 23 which is located closer to the display range line 77 than the point P in FIG. 7.

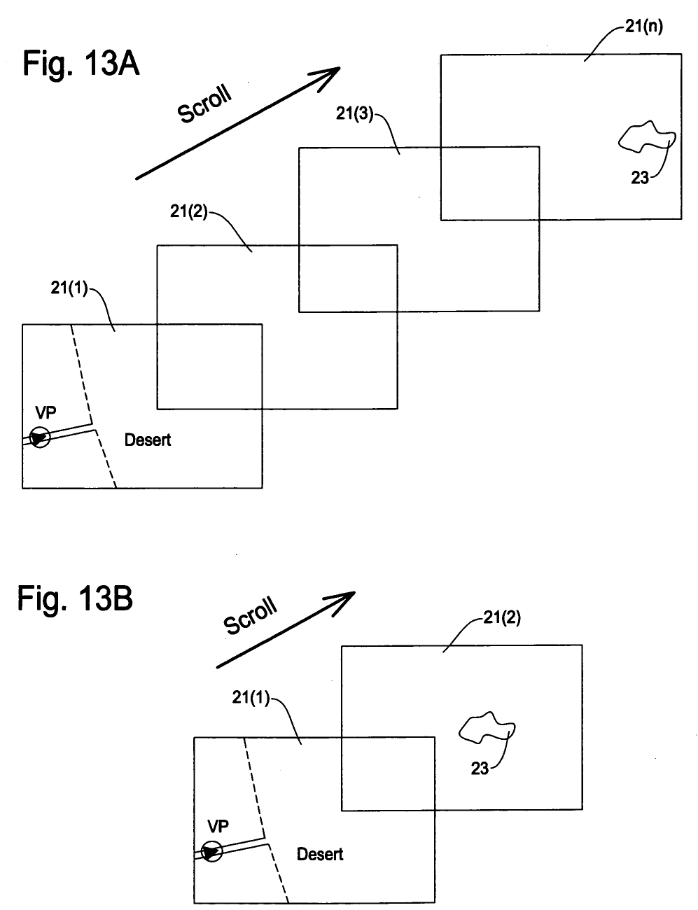

The navigation system repeats this procedure of FIG. 8 for all shape points of the object, thereby determining which part of the object should be displayed in the next screen. A center point P′ indicates a location where any shape point P of the object within the display range intersects with the center line 73 with a right angle. The center point P′ in FIG. 8 is closer to the current display screen 21 than the center point P′ in FIG. 7. Preferably, the center point P′ that is nearest to the current screen 21 will become the next center of the display screen when the navigation system jumps to the next screen (screen 21(2) of FIG. 13B).

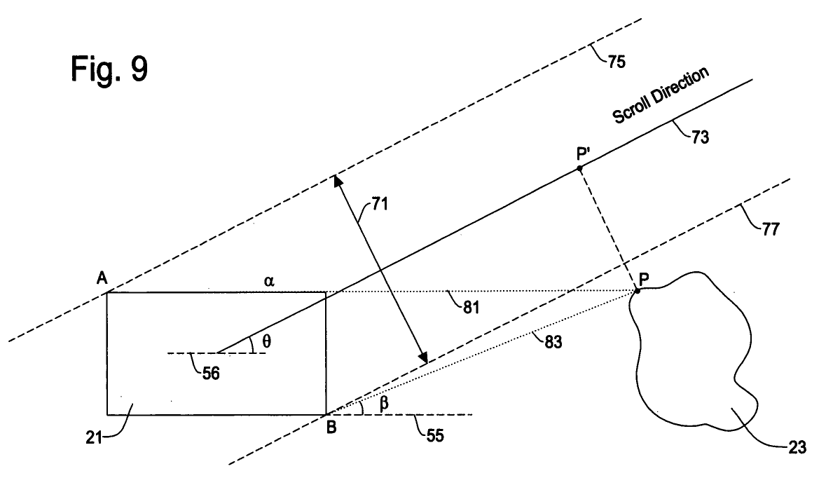

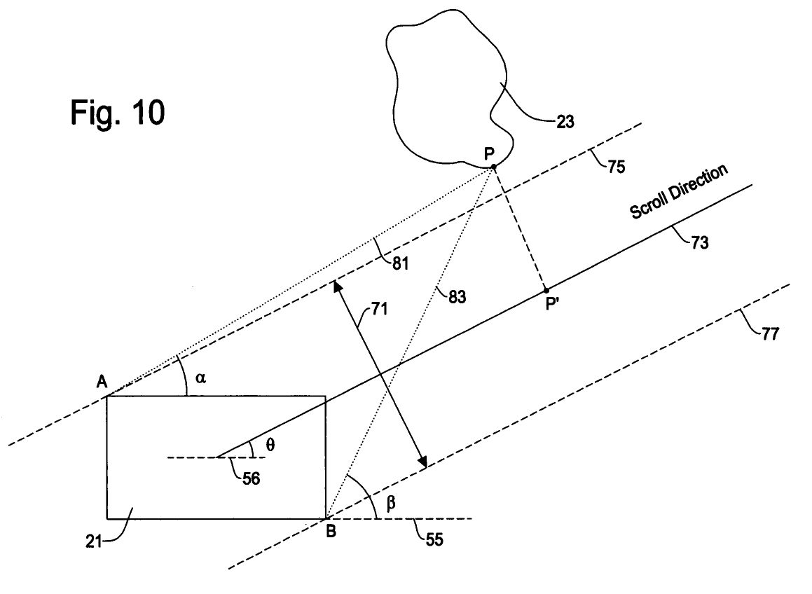

FIGS. 9 and 10 schematically show the situation where the pond 23 is not in the display range of the scroll direction, i.e., not a visible object. The navigation system checks to see whether the conditions noted above, i.e., “α>θ and β>θ” or “α<θ and β<” are satisfied for the shape point P on the pond 23. The navigation system can check this condition for all of the shape points of the object (pond 23). However, preferably, the navigation system selects the shape point which is closest to the display range by checking the latitude and longitude of the shape point and applies the above condition. If the closest shape point is not within the display range, the navigation system determines that all the other shape points are not in the display range, thereby increasing the processing speed.

In FIG. 9, because both angles α and β are smaller than the angle θ, the navigation system determines that the shape point P of the pond 23 is not within the display range. Similarly, in FIG. 10, because both angles α and β are larger than the angle θ, the navigation system determines that the shape point P of the pond 23 is not within the display range. Thus, in either case of FIG. 9 or 10, the navigation system determines that the pond 23 is not the object to be displayed. Then, the navigation system will read the map data further ahead of the scroll direction to find other visible artifacts and repeat the procedure described above for visible artifacts.

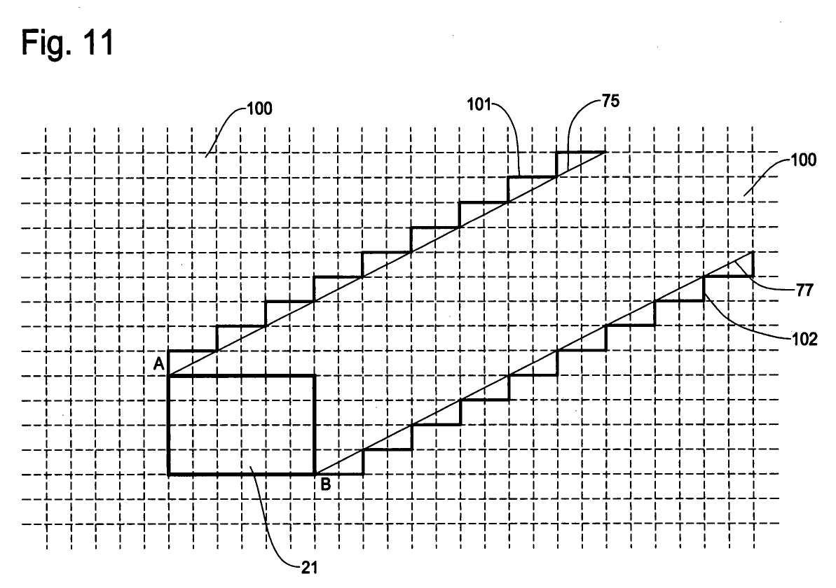

Although the present invention has been described above using the schematic views shown in FIGS. 7 to 10, in an actual implementation, the display screen of the navigator system is comprised up of a large number of dots in a matrix manner. Thus, as shown in FIG. 11, the lines in the user's scroll direction may not be completely straight. In FIG. 11, a zigzag line 101 is approximated to the line 75 starting from the point A, and a zigzag line 102 is approximated to the line 77 starting from the point B. Although each dot 100 shown in FIG. 11 is large, in the actual display, each dot 100 is much smaller that may not be discernible to the user.

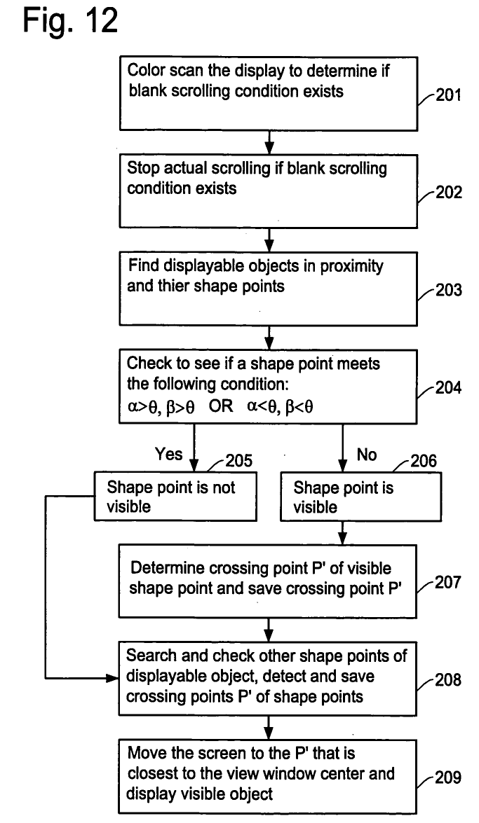

FIG. 12 is a flow chart showing the steps of determining the existence of the blank screen condition and reading the map data ahead in the scroll direction to find out a visible object to be displayed. In step 201, the navigation system color scans the display to determine if there is a sufficient color difference. If a sufficient color difference does not exist, the navigation system determines that there arises a blank scrolling condition.

In step 202, the navigation system will stop the actual scrolling of the display screen if it has determined that the blank scrolling condition exists. The navigation system searches for visible objects and their shape points in step 203 by evaluating the map data ahead in the scroll direction. If there is a visible object, for each shape point of the visible object, at step 204, the navigation system will check if the shape point will be within the display range by comparing angels α and β to an angle θ of the shape point.

If the shape point is visible, at step 206, the navigation system will register the point P's at step 207. The point P′ is a crossing point of the line 73 and the line drawn in perpendicular to the line 73 from the shape point. The navigation system will then check other shape points in step 208. In the case where the shape point is determined to be not visible in step 205, the navigation system will skip the step 207 and check other shape points of the visible object in the step 208. After checking the shape points, the navigation system moves the screen 21 to the location of the crossing point P′ that is nearest to the view window center in step 209.

FIG. 13A shows the situation where the blank scroll condition exists in the same manner as shown in FIG. 4. Thus, the user is unable to find any landmark on the map image of the display in the screens 21(2), 21(3), . . . , when keep scrolling the screen until reaching the screen 21(n). FIG. 13B is an example of a display of the present invention where the navigation system immediately displays the screen 21(2) showing the visible object (the pond 23). As described above, new screen is moved to the point P′ (not shown in FIG. 13B) which is the nearest point to the view window center with respect to the shape point on the visible object. Thus, the user is able to maintain the sense of direction and prepare for the next move.

As has been described above, according to the present invention, when the user scrolls the screen, since the navigation system is able to automatically move to the next visible object when the blank screen condition occurs, the user can maintain the sense of direction. In the application to the vehicle navigation system, the present invention contributes to safe driving by allowing the user to focus on the driving rather than operating the keys of the navigation system by quickly and easily moving to the screen showing a visible object. The present invention makes it possible to quickly scroll the screen to the location where a visible object exists with a small number of key operation. Accordingly, the present invention is also able to provide an easier and friendlier user interface.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

1. A display method for a navigation system, comprising the following steps of:
receiving a scroll signal from an input device operated by a user for scrolling a screen of a navigation system;
detecting a condition in which blank scroll will arise when the screen is scrolled, where the blank scroll is a situation of the screen which does not show any visible object thereon;
reading map data ahead in a scroll direction to find any visible object when the blank scroll condition is detected;
evaluating a shape point on a visible object to determine whether any part of the visible object should come within a display range of the screen when the screen is further scrolled; and
jumping to a location which shows the visible object when it is determined that any part of the visible object should come within the display range.

2. A display method for a navigation system as defined in claim 1, wherein said step of detecting the blank scroll condition includes a step of scanning the screen to see if there is any color difference on the screen, and if there is not a sufficient color difference, it is determined that the blank scroll condition exists.

3. A display method for a navigation system as defined in claim 1, wherein said step of detecting the blank scroll condition includes a step of examining map data for the screen to see if there is any data showing a visible object within the display range of the screen, and if there is not the map data showing the visible object, it is determined that the blank scroll condition exists.

4. A display method for a navigation system as defined in claim 1, further comprising a step of repeating said steps of reading the map data ahead in the scroll direction to find any visible object and evaluating a shape point on the visible object until a visible object that should come within the display range is detected.

5. A display method for a navigation system as defined in claim 1, further comprising a step of stop scrolling the screen even if the scroll signal is provided by the user, a step of repeating said steps of reading the map data ahead in the scroll direction to find any visible object and evaluating a shape point on a visible object until a visible object that should come within the display range is detected, thereby jumping to the location which shows the visible object within the display range.

6. A display method for a navigation system as defined in claim 1, wherein said step of reading the map data ahead in the scroll direction includes a step of determining the scroll direction based on the scroll signal generated by the input device.

7. A display method for a navigation system as defined in claim 1, wherein said step of evaluating the shape point on the visible object includes a step of drawing lines from the screen defining a display range of the screen if the screen is scrolled in the scroll direction and a center line from a center of the screen toward the scroll direction.

8. A display method for a navigation system as defined in claim 1, wherein said step of evaluating the shape point on the visible object includes a step of evaluating a plurality of shape points on the visible object to determine which part of the visible object should come within the display range when the screen is scrolled in the scroll direction.

9. A display method for a navigation system as defined in claim 1, wherein said step of evaluating the shape point on the visible object includes a step of drawing a first line from one corner of the screen which is one end of the display range to the shape point and a second line from another corner of the screen which is another end of the display range to the shape point, and a step of evaluating an angle α made by the first line, an angle β made by the second line, and an angle θ of the scroll direction for determining whether the shape point will be within the display range when the screen scroll is continued.

10. A display method for a navigation system as defined in claim 9, wherein said step of evaluating the angles includes a step of determining that the shape point will not come within the display range if a relationship of “α>θ and β>θ” or “α<θ and β<θ” is satisfied.

11. A display apparatus for a navigation system, comprising:
means for receiving a scroll signal from an input device operated by a user for scrolling a screen of a navigation system;
means for detecting a condition in which blank scroll will arise when the screen is scrolled, where the blank scroll is a situation of the screen which does not show any visible object thereon;
means for reading map data ahead in a scroll direction to find any visible object when the blank scroll condition is detected;
means for evaluating a shape point on a visible object to determine whether any part of the visible object should come within a display range of the screen when the screen is further scrolled; and
means for jumping to a location which shows the visible object when it is determined that any part of the visible object should come within the display range.

12. A display apparatus for a navigation system as defined in claim 11, wherein said means for detecting the blank scroll condition includes means for scanning the screen to see if there is any color difference on the screen, and if there is not a sufficient color difference, it is determined that the blank scroll condition exists.

13. A display apparatus for a navigation system as defined in claim 11, wherein said means for detecting the blank scroll condition includes means for examining map data for the screen to see if there is any data showing a visible object within the display range of the screen, and if there is not the map data showing the visible object, it is determined that the blank scroll condition exists.

14. A display apparatus for a navigation system as defined in claim 11, further comprising means for repeating said processes of reading the map data ahead in the scroll direction to find any visible object and evaluating a shape point on the visible object until a visible object that should come within the display range is detected.

15. A display apparatus for a navigation system as defined in claim 11, further comprising means for stopping the screen scroll even if the scroll signal is provided by the user, means for repeating said processes of reading the map data ahead in the scroll direction to find any visible object and evaluating a shape point on a visible object until a visible object that should come within the display range is detected, thereby jumping to the location which shows the visible object within the display range.

16. A display apparatus for a navigation system as defined in claim 11, wherein said means for reading the map data ahead in the scroll direction includes means for determining the scroll direction based on the scroll signal generated by the input device.

17. A display apparatus for a navigation system as defined in claim 11, wherein said means for evaluating the shape point on the visible object includes means for drawing lines from the screen defining a display range of the screen if the screen is scrolled in the scroll direction and a center line from a center of the screen toward the scroll direction.

18. A display apparatus for a navigation system as defined in claim 11, wherein said means for evaluating the shape point on the visible object includes means for evaluating a plurality of shape points on the visible object to determine which part of the visible object should come within the display range when the screen is scrolled in the scroll direction.

19. A display apparatus for a navigation system as defined in claim 11, wherein said means for evaluating the shape point on the visible object includes means for drawing a first line from one corner of the screen which is one end of the display range to the shape point and a second line from another corner of the screen which is another end of the display range to the shape point, and means for evaluating an angle α made by the first line, an angle β made by the second line, and an angle θ of the scroll direction for determining whether the shape point will be within the display range when the screen scroll is continued.

20. A display apparatus for a navigation system as defined in claim 19, wherein said means for evaluating the angles includes means for determining that the shape point will not come within the display range if a relationship of “α>θ and β>θ” or “α<θ and β<θ” is satisfied.
